(19) United States
(12) Patent Application Publication
(10) Pub. No.: US 2026/0059006 A1
(43) Pub. Date: Feb. 26, 2026

(54) METHOD FOR TRANSMITTING AND RECEIVING DATA IN REAL TIME AND DEVICE THEREFOR

(71) Applicant: TEAMGRIT, Gyeonggi-do (KR)

(72) Inventors: Sung Il KANG, Seoul (KR); Ki Ryeung KIM, Seoul (KR)

(73) Assignee: TEAMGRIT, Gyeonggi-do (KR)

(21) Appl. No.: 19/105,342

(22) PCT Filed: Feb. 9, 2023
(86) PCT No.: PCT/KR2023/001923

§ 371 Date: Feb. 21, 2025

(30) Foreign Application Priority Data
Aug. 23, 2022 (KR) 10-2022-0105640

(51) Int. Cl. H04L 65/65

(52) U.S. Cl. CPC H04L 65/65

(57) ABSTRACT

Disclosed are a method for transmitting and receiving data in real time and a device thereof. The transmission device transmits a first information message including data format information about a plurality of first data messages on the basis of text, and continuously transmits the plurality of first data messages. The first data message and the first information message are composed of at least one package and are messages in units of logical transmission and reception data units distinguishable in an application.

### TECHNICAL FIELD

An embodiment of the disclosure relates to a method for transmitting and receiving data and a device therefor, and more particularly, to a method for transmitting and receiving data in various formats in real time and a device therefor.

### BACKGROUND ART

There are various protocols used to transmit multimedia data such as video and audio in real time. For example, there are various protocols such as Real-Time Streaming Protocol (RTSP) mainly used in a Closed Circuit Television (CCTV), Web Real-Time Communication (WebRTC) used in video conferencing, and Secure Reliable Transport (SRT) or Reliable Internet Stream Transport (RIST) for ultra-low latency broadcasting. Since various conventional protocols are optimized for the transmission of particular data formats or applications, it is difficult to transmit multiple formats of data using a single protocol.

When multiple types of protocols are used together, the processing burden for protocol conversion, format conversion, codec conversion, etc. increases during interoperability, which increases system's performance requirements or increases operational complexity. For example, WebRTC, which has recently been attracting attention as a real-time protocol, has high specifications for supported codecs and is limited to free and standardized codecs due to the nature of web standards, and thus new codecs cannot be quickly applied to the WebRTC and used. Also, the WebRTC cannot optimize transmission data in a light-weighted form, and thus it difficult to apply the WebRTC to low-performance, low-spec IoT devices.

### DISCLOSURE OF INVENTION

### Technical Problem

The disclosure relates to a real-time data transmitting/receiving method of transmitting various types of data in real time regardless the specification and the number of hardware and an apparatus therefor.

### Solution to Problem

According to an embodiment of the disclosure, a method of transmitting data in real time performed by a transmitter includes transmitting a first information message including data type information of a first data message in a text-based manner; and sequentially transmitting a plurality of first data messages, wherein the first data message and the first information message are messages of logical transmission/reception data units each including at least one packet and being distinguishable by an application.

According to an embodiment of the disclosure, a method of receiving data in real time performed by a receiver includes, when a first information message transmitted in a text-based manner is received, identifying data type information through the first information message; and processing a data message received after receiving the first information message based on the data format information.

### Effects of Invention

According to an embodiment of the disclosure, data of various formats may be transmitted in real time. According to another embodiment, even when a new codec or a new transmission technique is introduced, the new codec or the new transmission technique may be accepted and data may be transmitted without codec conversion or format conversion, and thus data formats used in various protocols may be accepted while minimizing problems such as information loss or processing delay due to codec conversion or format conversion. According to another embodiment, new protocols may be defined and used in various ways in the form of application programming interfaces (API), and thus the extensibility for accepting new protocols is also excellent.

### BRIEF DESCRIPTION OF DRAWINGS

FIG. 1 is a drawing illustrating an example of data transmitting and receiving devices according to an embodiment of the disclosure,

FIG. 2 is a diagram illustrating an example of a method of transmitting streaming data according to an embodiment of the disclosure,

FIGS. 3 and 4 are drawings illustrating an example of a display format of an information message according to an embodiment of the disclosure,

FIG. 5 is a diagram illustrating an example of a method of transmitting various types of streaming data according to an embodiment of the disclosure,

FIG. 6 is a diagram illustrating an example of a method of periodically transmitting an information message according to an embodiment of the disclosure,

FIG. 7 is a flowchart of an example of a method of transmitting data in real time by a transmitter, according to an embodiment of the disclosure,

FIG. 8 is a flowchart of an example of a method of receiving data in real time by a receiver, according to an embodiment of the disclosure, and,

FIG. 9 is a diagram illustrating an example of a state transition diagram for streaming data processing, according to an embodiment of the disclosure.

### MODE FOR THE INVENTION

Hereinafter, a method for transmitting and receiving data in real time and a device therefor according to an embodiment of the disclosure will be described in detail with reference to the attached drawings.

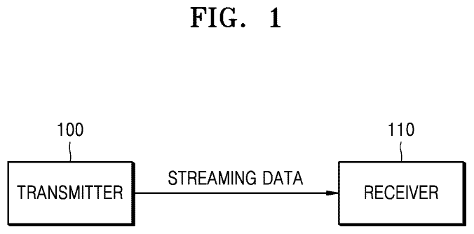

FIG. 1 is a drawing illustrating an example of data transmitting and receiving devices according to an embodiment of the disclosure.

Referring to FIG. 1, a transmitter 100 is a subject that transmits streaming data, and a receiver 110 is a subject that receives streaming data. The transmitter 100 and the receiver 110 are both terminals capable of Internet communication and may be of various types, such as general computers, servers, and smartphones. For example, the transmitter 100 may be a device that transmits multimedia data for broadcasting or advertising.

For convenience of explanation, the present embodiment illustrates one receiver 110, but a plurality of receivers 110 may be connected to the transmitter 100. In other words, the transmitter 100 may transmit streaming data to the plurality of receivers 110 in various ways, such as broadcasting or multicasting.

The transmitter 100 and receiver 110 may transmit and receive streaming data using a web-based transmission protocol. For example, the transmitter 100 and the receiver 110 may transmit and receive streaming data using WebTransport or Web Socket.

Streaming data is data transmitted in real time by the transmitter 100. Streaming data may include various types of data, such as image data, video data, audio data, and text data, but is not limited to a particular type. The receiver 110 may play streaming data in real time when the receiver 110 receives the streaming data.

Streaming data may include data of various codecs or various compression formats. For example, first video data may be compressed with a first codec and second video data may be compressed with a second codec. Image data, audio data, text data, etc. may be of the same type, but codecs and compression methods used therefor may be different.

Conventionally, when transmitting data, the optimal protocol for the type of the data was used. For example, when a transmitter transmits CCTV, RTSP is used, and, when the transmitter transmits video conferencing video, WebRTC or the like is used. Therefore, there is an inconvenience that different transmission protocols need to be used depending on the type of streaming data transmitted by the transmitter.

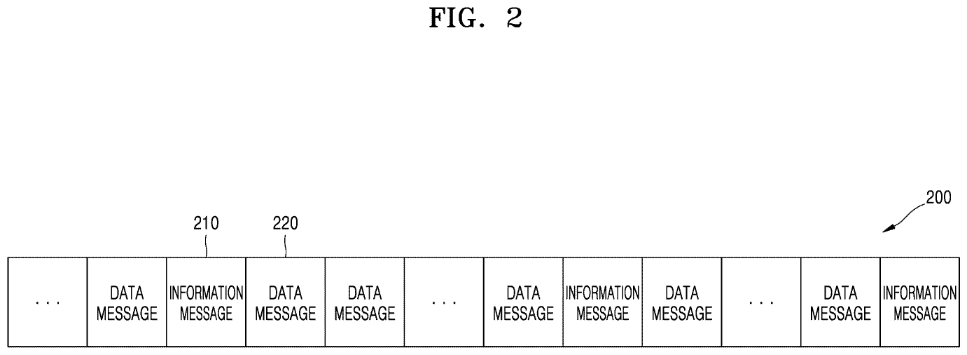

Therefore, the present embodiment provides a method of transmitting various types of streaming data by connecting the transmitter 100 and the receiver 110 by using a web-based transmission protocol. Detailed descriptions thereof will be given later with reference to the drawings from FIG. 2.

FIG. 2 is a diagram illustrating an example of a method of transmitting streaming data according to an embodiment of the disclosure.

Referring to FIG. 2, a transmitter transmits a flow 220 of an information message 210 and a data message 220 to a receiver. The information message 210 and the data message 220 are messages in logical transmitting and receiving data units that may be distinguished by an application and each include at least one packet. A packet is a unit of data transmission and reception of lower transport layers such as Transmission Control Protocol (TCP) and User Datagram Protocol (UDP). Packets may be in the format of various codecs, various compression protocols (e.g., JPEP, etc.), or various transmission protocols (e.g., WebRTC, RTSP, etc.).

According to an embodiment, to distinguish between the information message 210 and the data message 220, the data message 220 may use a binary message format and the information message 210 may use a text message format. According to another embodiment, an additional header or type may be defined in packets of a lower transmission layer and used to distinguish between two messages 210 and 220. Hereinafter, it is assumed that the data message 220 is transmitted in a binary message format and the information message 210 is transmitted in a text message format, such that the receiver 110 distinguishes between two messages.

Streaming data transmitted by the transmitter 100 is transmitted in the unit of a plurality of data messages 220. The information message 210 includes data format information of the data message 220. For example, when the data message 220 is video data compressed with the VP8 codec, the information message 210 includes information that the data type of the data message 220 is ‘video data’ and the codec is ‘VP8’. The transmitter 100 only needs to transmit packets of streaming data as data message units without having to change the format of the packets that constitute the streaming data.

The transmitter 100 and the receiver 110 do not consult with each other in advance about what type of streaming data to transmit, and the transmitter 100 unilaterally transmits various types of streaming data. To enable the receiver 110 to easily interpret the information message 210, the information message 210 is transmitted in text format. As an example of a method of transmitting the information message 210 in a text-based manner, the Multipurpose Internet Mail Extensions (MIME) format may be used. In addition to this, various methods of transmitting the information message 210 in a text-based manner may be applied to the present embodiment. However, for convenience of explanation, it is assumed below that the information message 210 is defined and transmitted using the MIME format.

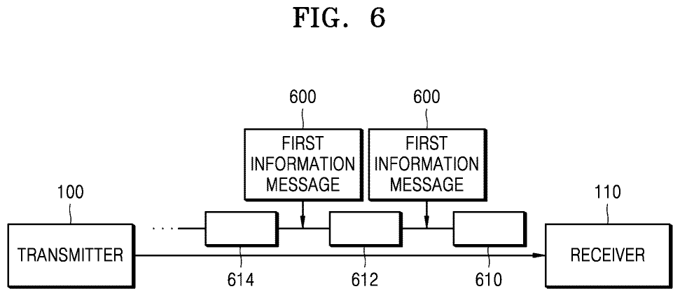

According to an embodiment, when transmitting streaming data, the transmitter 100 may repeatedly transmit the information message 210 at a certain interval, such that a new receiver may receive and play the streaming data from the middle of the transmission. Detailed description thereof will be given later with respect to FIG. 6.

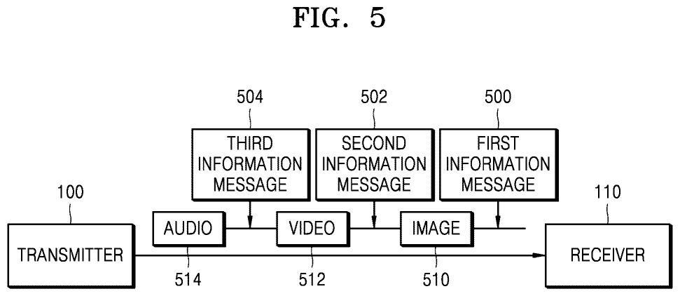

According to another embodiment, the transmitter 100 may transmit various types of streaming data in real time while maintaining the connection with the receiver 110 without having to establish a new connection. To this end, the transmitter 100 may transmit the information message 210 whenever the type of streaming data being transmitted is changed. Detailed description thereof will be given later with respect to FIG. 5.

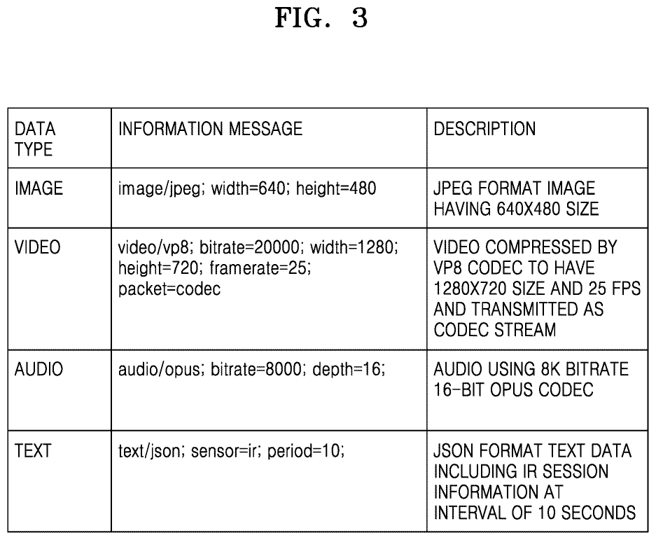

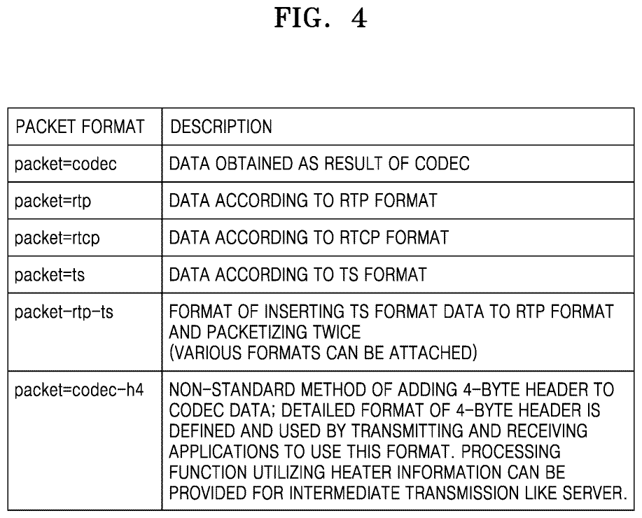

FIGS. 3 and 4 are drawings illustrating an example of a display format of an information message according to an embodiment of the disclosure.

Referring to FIG. 3, the information message 210, which is transmitted using the MIME format, may define data format information of the data message 220 t. For example, the information message 210 may include information such as the type and the format of streaming data or codec. For example, when the streaming data is image data compressed with JPEG, the information message 210 may include ‘image’ representing that the streaming data is image data, the size of a corresponding image, and information indicating that the compression codec is JPEG. Since the information message 210 is defined in the text format, it may be used by extending the options or defining a new data format (i.e., new media).

Referring to FIG. 4, the information message 210 may include information that distinguishes packets constituting the streaming data according to the format of a specific protocol. For example, when the streaming data of FIG. 3 is in the form of video data, an option “packet=” may be used in an information message to define the format of packets constituting the streaming data. There are various types of packet format, such as Real-Time Transport Protocol (RTP), Transport Stream (TS), Gstreamer Data Protocol (GDP), and raw. The information message may include “packet=codec” when packets of streaming data are data resulting from a codec or may include “packet=rtp” when packets of the streaming data are data in the RTP format. For efficiency, packets generated by a compression codec, etc. may be transmitted as-is without adding a separate header, such as “packet=codec”. In other words, when streaming data is data generated by various codecs or various protocols such as RTP and RTCP, packets may be transmitted as-is through the transmitting method of FIG. 2 without having to change the packets of the streaming data. The receiver 110 may determine whether streaming data is in a packet format such as RTP or RTCP through the information message 210, and may process a received data message using a corresponding protocol and play back processed data message.

Since the present embodiment only uses the rules of the text-based MIME format in consideration of web compatibility and readability, the information message 210 does not necessarily need to match the MIME. For example, the transmitter 100 may follow the format of standard HTTP MIME information, but may provide an API that allows a user to define and use various streaming data and packet formats.

Since streaming data in various forms may be transmitted by using the information messages 210 in the present embodiment, it is possible to internally accommodate data formats of various protocols, and thus it may be conveniently used without loss of efficiency and without the burden of conversion when linking different protocols. It may also support a wide range of streaming applications, from the most complex WebRTC format data to the simplest data format. In other words, by applying the method of transmitting and receiving data of the present embodiment, multimedia streaming may be implemented even on low-spec IoT devices, and high-quality, low-latency streaming may be implemented even on high-spec devices with a more optimized transmission technique.

FIG. 5 is a diagram illustrating an example of a method of transmitting various types of streaming data according to an embodiment of the disclosure.

Referring to FIG. 5, the transmitter 100 may sequentially transmit image data 510, video data 512, audio data 514, etc. in real time while being connected to the receiver 110. The transmitter 100 first transmits an information message 500, 502, or 504 before transmitting streaming data to inform the receiver 110 of the data format of the streaming data to be transmitted.

For example, before transmitting the image data 510, the transmitter 100 transmits a first information message 500 indicating that the data type of the streaming data is an image. Also, the transmitter 100 transmits a second information message 502 indicating that the data type of streaming data is video before transmitting the video data 512, and transmits a third information message 504 indicating that the data type of streaming data is audio before transmitting the audio data 514. Therefore, the receiver 110 may determine what type of data the streaming data received is through the first information message 500, the second information message 502, and the third information message 504. Since information messages 500, 502, and 504 are transmitted in text format, the receiver 110 may read the information messages as-is to recognize their contents.

In another example, the transmitter 100 may transmit a second data message momentarily while transmitting the first data message and then resume transmission of the first data message. To this end, the transmitter 100 may transmit a first information message regarding the first data message, a second information message regarding the second data message, and again the first information message regarding the first data message before transmission of each data message.

FIG. 6 is a diagram illustrating an example of a method of periodically transmitting an information message according to an embodiment of the disclosure.

Referring to FIG. 6, the transmitter 100 may periodically transmit a first information message 600 while transmitting data messages 610, 612, and 614 of one type of streaming data. The repeated transmission cycle of the first information message 600 may be set in various ways depending on applications, etc.

A new second receiver (not shown) may be connected to the transmitter 100 during transmission of streaming data and receive streaming data from a middle portion. However, the second receiver (not shown) is unable to play a data message received from the middle portion, because the second receiver (not shown) does not know what type of streaming data the data message is. The second receiver (not shown) waits until the first information message 600 to determine the type of streaming data is received. For example, when the second receiver (not shown) receives the first information message 600 that is transmitted for the second time, the second receiver (not shown) may identify the data format of the streaming data and then process and play back a next received data message 614 according to an identified data format. The second receiver (not shown) may discard all data messages received before the first information message 600 is received.

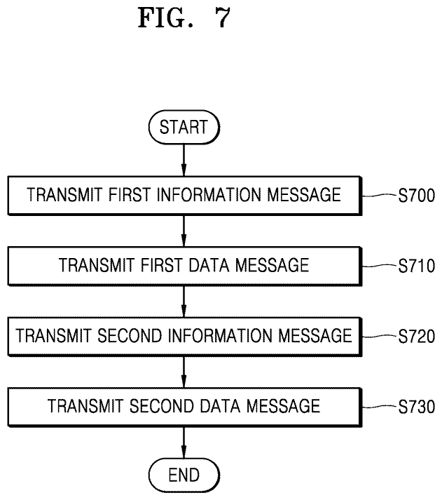

FIG. 7 is a flowchart of an example of a method of transmitting data in real time by a transmitter, according to an embodiment of the disclosure.

Referring to FIG. 7, the transmitter 100 transmits a first information message including data type information of a first data message in a text-based manner (S700). The transmitter 100 may sequentially transmit a plurality of first data messages after transmitting the first information message (S710). Here, the first data message and the first information message are messages of logical transmission/reception data units that include at least one packet and may be distinguished by an application. The first information message is defined in the MIME format, wherein an example of which is illustrated in FIGS. 3 and 4.

According to another embodiment, the transmitter 100 may repeatedly transmit a first information message at regular intervals for a receiver that receives streaming data from a middle portion. An example thereof is shown in FIG. 6.

When a second data message having a different data format from that of a first data message is to be transmitted, the transmitter 100 transmits a second information message indicating the data format of the second data message (S720). The transmitter 100 transmits the second data message after transmitting the second information message (S730). According to another embodiment, the transmitter 100 may repeatedly transmit a second information message at regular intervals.

The transmitter 100 and the receiver 110 may transmit and receive different types of streaming data in real time while maintaining the web connection. For example, the transmitter 100 may sequentially transmit the first information message, at least one first data message, the second information message, and at least one second data message described above through one connection.

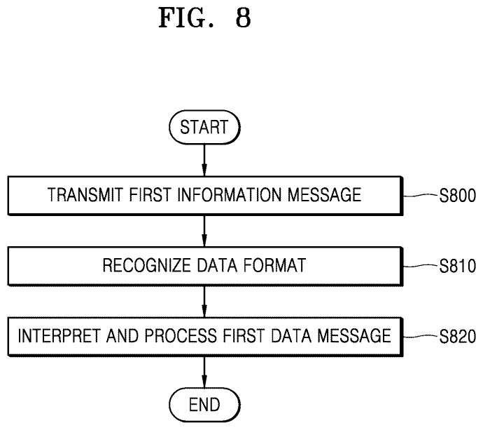

FIG. 8 is a flowchart of an example of a method of receiving data in real time by a receiver, according to an embodiment of the disclosure.

Referring to FIG. 8, when the receiver 110 receives a first information message transmitted in a text-based manner (S800), the receiver 110 determines the data format of the streaming data through the first information message (S810). The receiver 110 processes and plays back a data message received after the reception of the first information message based on data format information (S820). For example, when streaming data includes packets generated by a particular codec or RTP, the receiver 110 may decode and interpret the packets of the streaming data using the particular codec or RTP, etc., based on the first information message. The receiver 110 may transmit streaming data (e.g., video, audio, etc.) to each playback device (video playback application, audio playback application, etc.) according to the data format and play back the streaming data.

According to another embodiment, the receiver 110 may not receive streaming data transmitted by the transmitter 100 from the beginning, but may be connected to the transmitter 100 from a middle portion and receive the streaming data from the middle portion. At this time, the receiver 110 may discard a first data message received before receiving a first information message and process and play back a first data message received after receiving the first information message.

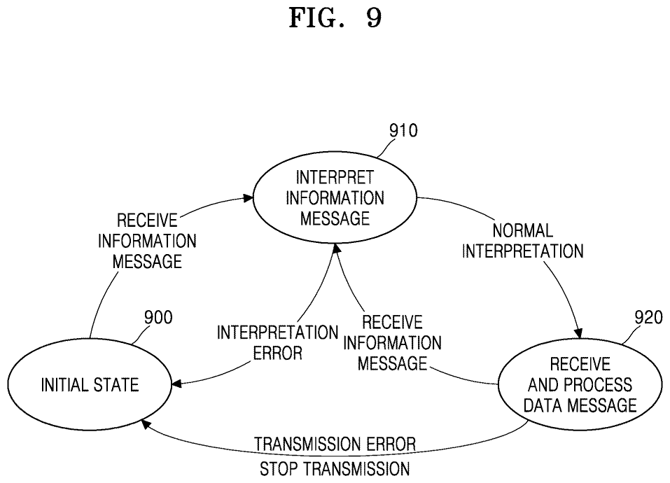

FIG. 9 is a diagram illustrating an example of a state transition diagram for streaming data processing, according to an embodiment of the disclosure.

Referring to FIG. 9, the receiver 110 stands by to receive an information message in an initial state 900. When a text-based information message is received, the receiver 110 transitions to an information message decoding state 910. When there is an error in decoding of the information message, the receiver 110 returns to the initial state 900 and stands by until a new information message is received.

When decoding of the information message is completed normally, the receiver 110 transitions to a data message reception and processing state 920. When an information message is received during the reception and processing of a data message, the receiver 110 transitions back to the information message decoding state 910. When an error occurs in decoding, the receiver 110 stands by in the initial state 900 until a new information message is received. Also, when a transmission error or a transmission interruption occurs in the data message reception and processing state 920, the receiver 110 becomes the initial state 900 and stands by for reception of an information message.

The disclosure may also be implemented as computer-readable codes on a computer-readable recording medium. The computer-readable recording medium includes all types of recording devices in which information readable by a computer system is stored. Examples of computer-readable storage medium include ROM, RAM, CD-ROM, SSD, and optical data storage devices. Also, the computer-readable recording medium may be distributed in a network-connected computer system to store and execute computer-readable codes in a distributed manner.

Preferred embodiments of the disclosure have been described above. One of ordinary skill in the art will understand that the disclosure may be implemented in modified forms without departing from the essential characteristics of the disclosure. Therefore, the disclosed embodiments should be considered from an illustrative perspective rather than a restrictive perspective. The scope of the disclosure is indicated by claims, not foregoing descriptions, and all differences within the scope equivalent thereto should be construed as being included in the disclosure.

1. A method of transmitting data in real time performed by a transmitter, the method comprising:
transmitting a first information message comprising data type information of a first data message in a text-based manner; and
sequentially transmitting a plurality of first data messages,
wherein the first data message and the first information message are messages of logical transmission/reception data units each comprising at least one packet and being distinguishable by an application.

2. The method of claim 1, wherein the first information message defines the data type information in Multipurpose Internet Mail Extensions (MIME) format.

3. The method of claim 1, wherein the transmitting of the first information message comprises transmitting a first information message repeatedly at regular intervals].

4. The method of claim 1, further comprising:
transmitting a second information message comprising new data type information; and
transmitting a second data message in a new data format after transmitting the second information message.

5. The method of claim 4, wherein the first information message, the first data message, the second information message, and the second data message are transmitted while maintaining a state being connected to at least one recipient using a web-based transmission protocol.

6. A method of receiving data in real time performed by a receiver, the method comprising:
identifying data type information through the first information message in response to a first information message transmitted in a text-based manner is received; and
processing a data message received after receiving the first information message based on the data format information.

7. The method of claim 6, further comprising:
processing a second data message received after a second information message by using data format information included in the second information message in response to the second information message different from the first information message is received.

8. The method of claim 6, wherein the first information message defines the data type information in Multipurpose Internet Mail Extensions (MIME) format.

9. A computer-readable recording medium having recorded thereon a computer program for performing the method of claim 1.
